(19) United States
(12) Patent Application Publication
(10) Pub. No.: US 2025/0111470 A1
(43) Pub. Date: Apr. 3, 2025

(54) ENHANCING REMOTE VISUAL INTERACTION

(71) Applicant: DOLBY LABORATORIES LICENSING CORPORATION, San Francisco, CA (US)

(72) Inventors: Ajit Ninan, San Jose, CA (US); Paul Holmberg, North Ryde (AU)

(73) Assignee: DOLBY LABORATORIES LICENSING CORPORATION, San Francisco, CA (US)

(21) Appl. No.: 18/833,145

(22) PCT Filed: Jan. 30, 2023
(86) PCT No.: PCT/US2023/011858

§ 371 Date: Jul. 25, 2024

Related U.S. Application Data
(60) Provisional application No. 63/305,659, filed on Feb. 1, 2022.

(30) Foreign Application Priority Data
Feb. 9, 2022 (EP) 22155830.7

(51) Int. Cl. G06T 3/18; G06F 3/01

(52) U.S. Cl. CPC G06T 3/18; G06F 3/013

(57) ABSTRACT

A communication client device operated by a first user in a communication session receives a viewing direction tracking data portion indicating a view direction of a second user in the communication session. It is determined that the view direction of the second user is towards a third user at a first time point in the communication session. The view direction of the second user is used to modify a pre-adapted visual depiction of the second user into an adapted visual depiction of the second user. The adapted visual depiction of the second user is rendered, to the first user, on an image display operating with the communication client device.

### CROSS-REFERENCE TO RELATED APPLICATION

This application claims priority to the U.S. Provisional Application No. 63/305,659 filed Feb. 1, 2022 and European Patent Application No. 22155830.7 filed Feb. 9, 2022, all of which is incorporated herein by reference in its entirety.

### TECHNOLOGY

The present invention relates generally to visual or audiovisual communications, and in particular, to enhancing remote visual interaction in computer network enabled communications.

### BACKGROUND

Web based or internet based communications have become commonplace in personal and business activities. Frequently, multiple participants may conduct a video conference using their computers or mobile computing devices at various geographic locations in real time or near real time. Visual depictions of some or all other participants may be displayed on an image display to a participant, while audio sounds of any unmuted talkers among the other participants may be rendered or reproduced on audio speakers or earphones to the participant. Likewise, a visual depiction of the participant as well as any audio signal captured with microphone(s) from the participant can be conveyed to communication devices of the other participants for rendering or reproduction to the other participants at far ends relative to the participant.

However, it is often impossible to determine whether any participant is paying attention to or turning attention away from any other participant based on visual depictions of the participant as captured by cameras, resulting in much less effective interaction in web based or internet based visual or audiovisual communications than in person communications, especially when such communications involve more than two people at the same time.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1A illustrates an example system environment; FIG. 1B, FIG. 1C, FIG. 1G and FIG. 1H illustrate example operational scenarios; FIG. 1D and FIG. 1I illustrate example communication client devices; FIG. 1E and FIG. 1F illustrates example image warping operations;

FIG. 2 is an example AI/ML framework for enhancing remote visual interaction;

FIG. 3A through FIG. 3C illustrate example rendered images in a communication session; FIG. 3D illustrates an example layout for visual depictions of users in a communication session;

FIG. 4A and FIG. 4B illustrate example process flows; and

FIG. 5 illustrates an example hardware platform on which a computer or a computing device as described herein may be implemented.

### DESCRIPTION OF EXAMPLE EMBODIMENTS

Example embodiments, which relate to enhancing remote visual interaction, are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

Example embodiments are described herein according to the following outline:
1. GENERAL OVERVIEW
2. COMMUNICATION DEVICES FOR REMOTE COMMUNICATIONS
3. PREDICTIVE MODELS FOR ENHANCING REMOTE VISUAL INTERACTIONS
4. VISUAL DEPICTIONS OF USERS
5. ENHANCING REMOTE VISUAL INTERACTION WITHOUT GAZE TRACKING
6. EXAMPLE PROCESS FLOWS
7. IMPLEMENTATION MECHANISMS-HARDWARE OVERVIEW
8. EQUIVALENTS, EXTENSIONS, ALTERNATIVES AND MISCELLANEOUS

### 1. General Overview

This overview presents a basic description of some aspects of an example embodiment of the present invention. It should be noted that this overview is not an extensive or exhaustive summary of aspects of the example embodiment. Moreover, it should be noted that this overview is not intended to be understood as identifying any particularly significant aspects or elements of the example embodiment, nor as delineating any scope of the example embodiment in particular, nor the invention in general. This overview merely presents some concepts that relate to the example embodiment in a condensed and simplified format, and should be understood as merely a conceptual prelude to a more detailed description of example embodiments that follows below. Note that, although separate embodiments are discussed herein, any combination of embodiments and/or partial embodiments discussed herein may be combined to form further embodiments.

Techniques as described herein can be used to significantly enhance or inject remote visual interaction in a web-based or network-based communication session that involves three or more users (or human participants). For each user or participant, a unique perspective is provided to indicate to whom any other users or counterpart participants in the same communication session are looking or paying attention.

A first user's gaze (from pupil to specific display screen spatial location corresponding) to visual representations of other users depicted in rendered images (e.g., two-dimensional or 2D visual representation, three-dimensional or 3D visual representation, 2D or 3D video, etc.) on a display screen of an image display operated by the first user is tracked, for example automatically by gaze tracking device(s) (also referred to as “gaze tracker”) without any user input from the first user. Resultant eye tracker data can be used to determine or identify any second user to whom the first user may be directing the gaze—at any given time point in the communication session-toward, on, or away from, a visual representation of the second user depicted in the rendered images on the display screen of the image display operated by the first user.

In a first example, tracking data indicates that the first user is looking or turning toward a visual representation of the second user on the image display operated by the first user. The tracking data may be received by communication client devices operated by the other users. Through image warping, the first user can be depicted in visual representations in other rendered images on display screens of image displays operated by the other users to indicate that the first user is turning toward a visual representation of the second user, for example on the way or even reaching a point to be depicted as having eye-to-eye contact with the second user in the other rendered images, even though the first user and the second user may not even be in the same physical location and may not have any physical eye-to-eye contact. In addition, if the first user is looking at the user to which a visual representation of the first user is rendered, the first user can be depicted as directly facing and gazing out of a display screen at the user.

In a second example, tracking data indicates that the first user is looking or turning away from a visual representation of the second user on the image display operated by the first user. The tracking data may be received by communication client devices operated by the other users. Through image warping, the first user can be depicted in visual representations in other rendered images on display screens of image displays operated by the other users to indicate that the first user is turning away from a visual representation of the second user. In addition, if the first user is looking at the user to which a visual representation of the first user is rendered, the first user can be depicted as not directly facing and or not gazing out of a display screen at the user.

Image warping used to modify or adapt camera-captured visual representations of the users into non-camera-captured visual representations of the users may or may not be artificial intelligence (AI) based, machine learning (ML) based, etc. For example, image warping as described herein may be based on image interpolation, image selection, AI/ML based image prediction, etc. In operational scenarios in which AI/ML prediction models are used to estimate or predict warped images from input images, artificial neural networks (ANN) can be used to implement the prediction models. Additionally, optionally or alternatively, prediction models for image warping may be implemented with other AI/ML techniques other than ANNs.

Additionally, optionally or alternatively, some or all techniques as described herein can be used to enable a visual representation of when third parties (or other users in the same communication session) are paying attention to a user or speaker but does not convey who they are paying attention to when the third parties are not paying attention to the user or speaker. Metadata such as visual depiction data may be exchanged or communicated to specify where an image portion depicting the user or speaker is displayed on each third party's image display. The communication operated by the user or speaker can see a (e.g., virtual camera, etc.) video feed containing a visual depiction of the third party that appears to come from a camera placed on the third party's image display or display screen in or at the location where the image portion depicting the user or speaker is displayed or rendered. The visual depiction of the third party may be generated by warping a real camera image portion of the third party from a real camera location to the location where the image portion depicting the user or speaker is displayed or rendered is displayed on the third party's image display. Different users in the same communication session may receive different visual depictions of the same user (the third party in the present example) based on their locations on the user's image display. Some or all of these different visual depictions of the same user may be generated from image warping operations from a real camera image portion.

Example embodiments described herein relate to enhancing remote visual interaction. A communication client device operated by a first user in a communication session receives a viewing direction tracking data portion indicating a view direction of a second user in the communication session. It is determined that the view direction of the second user is towards a third user at a first time point in the communication session. The view direction of the second user is used to modify a pre-adapted visual depiction of the second user into an adapted visual depiction of the second user. The adapted visual depiction of the second user is rendered, to the first user, on an image display operating with the communication client device.

Example embodiments described herein relate to enhancing remote visual interaction. A communication client device operated by a first user in a communication session generates two or more image portions of the first user from two or more different camera perspectives for two or more other users in the communication session. The communication client device provides a first image portion of the first user from a first camera perspective to a first other communication client device operated by a first other user in the two or more other users. The communication client device provides a second image portion of the first user from a second camera perspective to a second other communication client device operated by a second other user in the two or more other users, the first camera perspective being different from the second camera perspective.

In some example embodiments, mechanisms as described herein form a part of a media processing system, including but not limited to any of: cloud-based server, mobile device, virtual reality system, augmented reality system, head up display device, helmet mounted display device, CAVE-type system, wall-sized display, video game device, display device, media player, media server, media production system, camera systems, home-based systems, communication devices, video processing system, video codec system, studio system, streaming server, cloud-based content service system, a handheld device, game machine, television, cinema display, laptop computer, netbook computer, tablet computer, cellular radiotelephone, electronic book reader, point of sale terminal, desktop computer, computer workstation, computer server, computer kiosk, or various other kinds of terminals and media processing units.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2. Communication Devices for Remote Communications

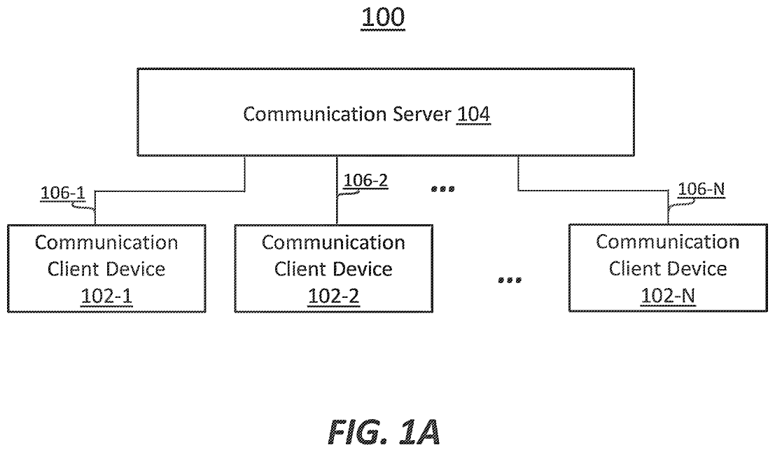

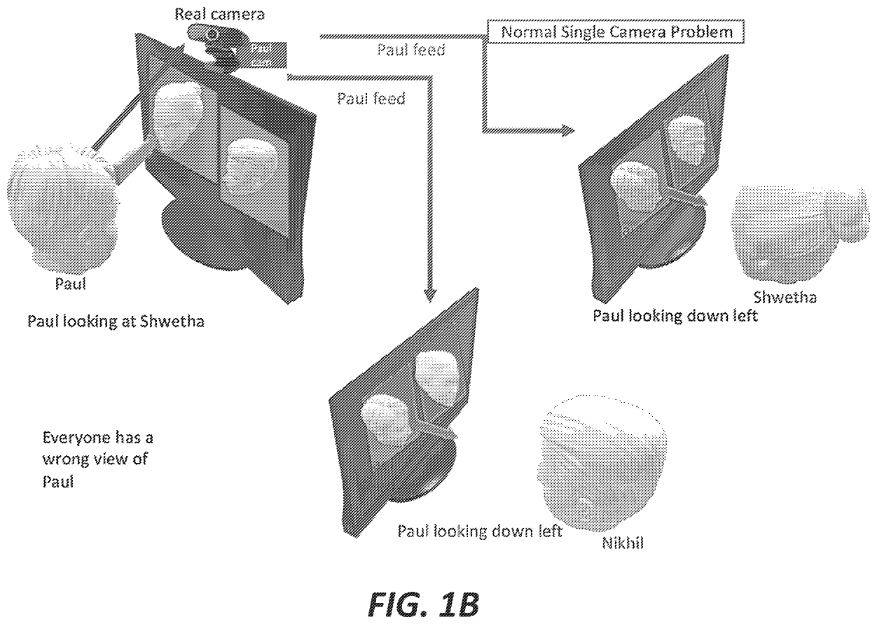

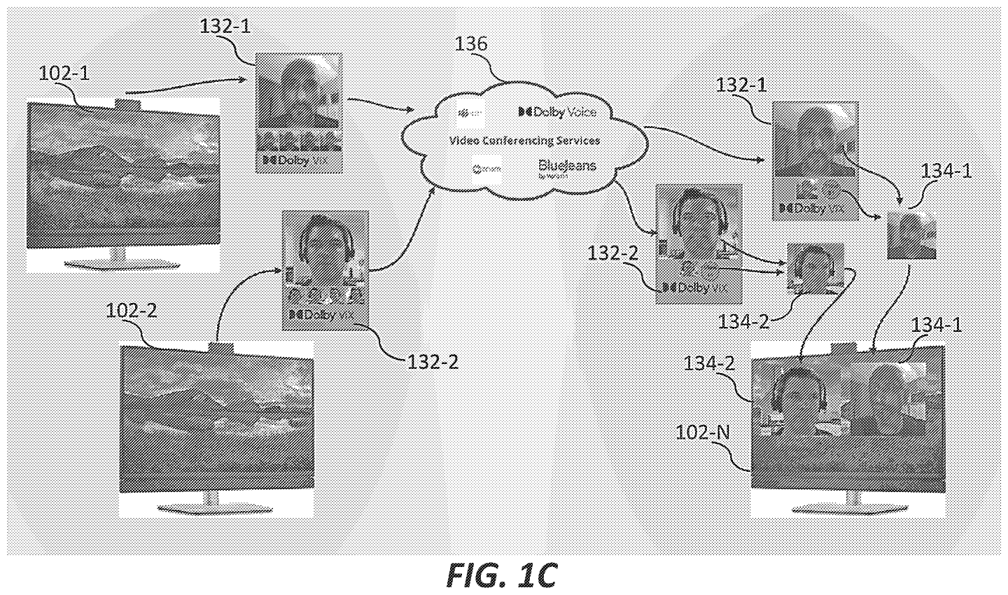

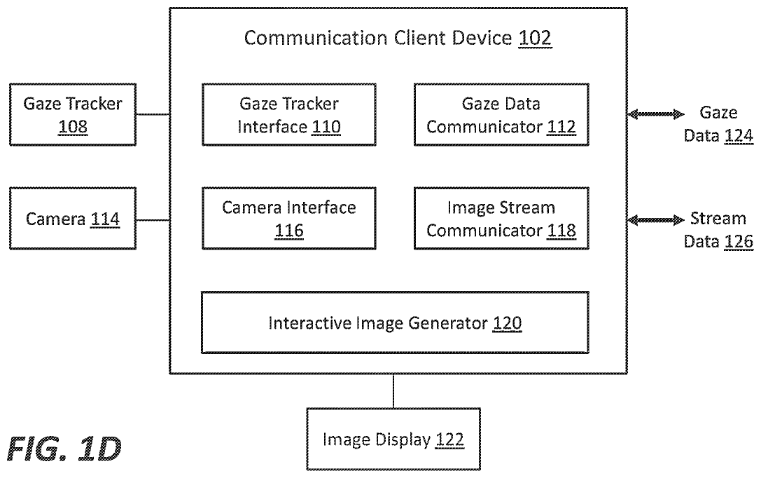

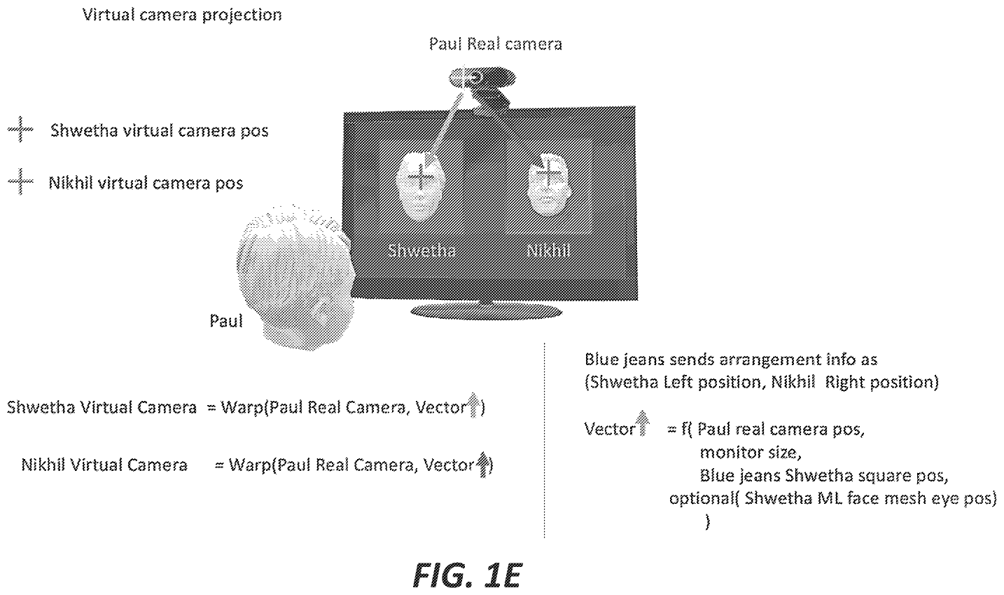

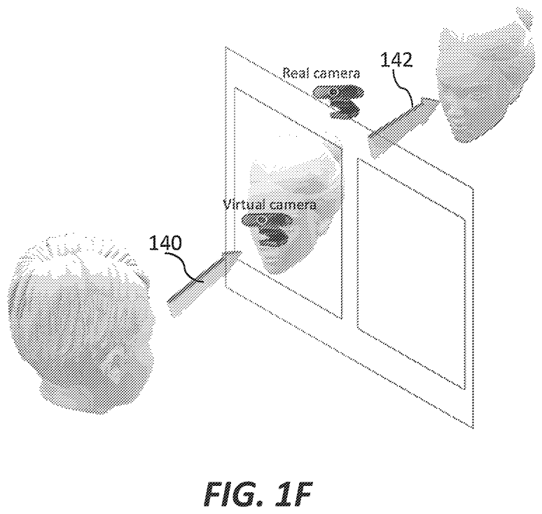

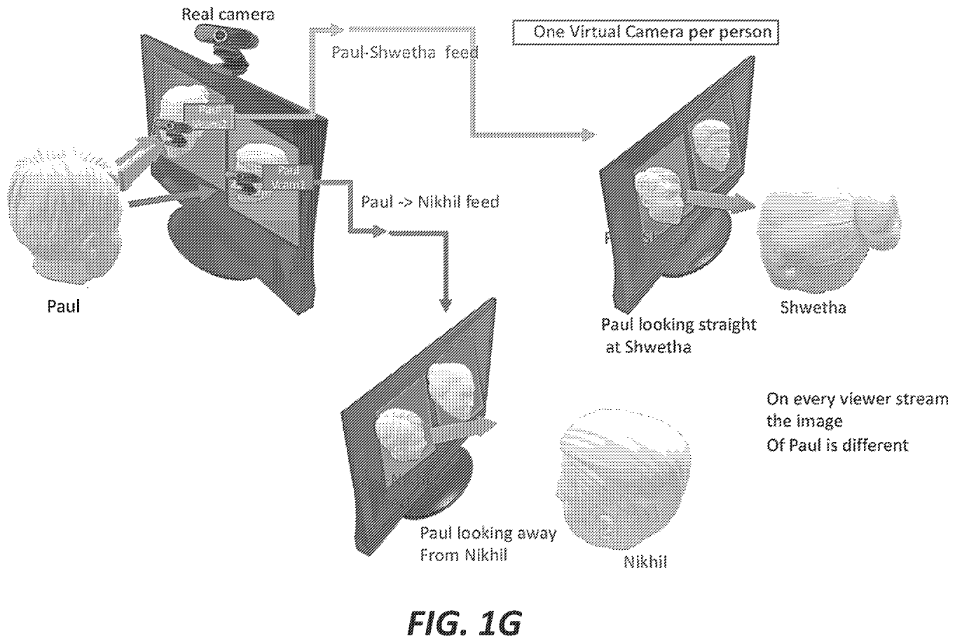

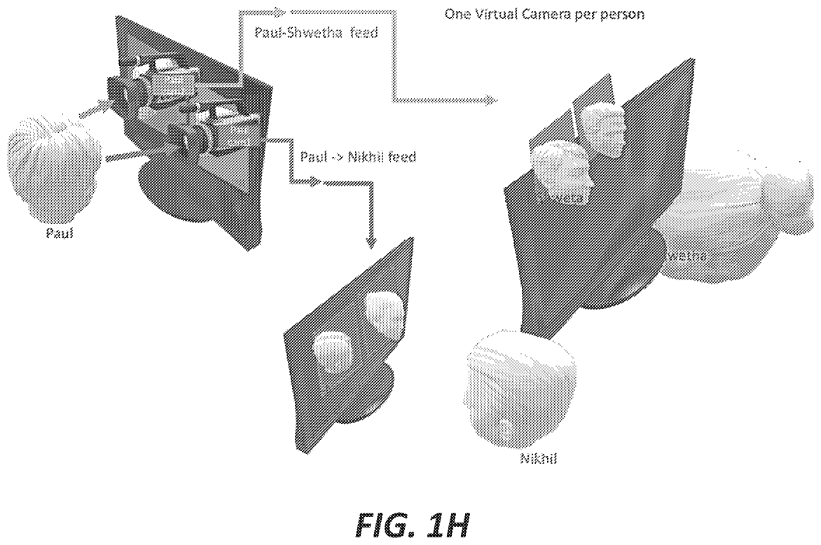

FIG. 1A illustrates an example system environment 100 for enhancing remote visual interaction in computer network enabled remote meetings (e.g., real time, near real time, web meetings, web conferences, teleconferences, webinars, web based club activities, social network activities, etc.). Some or all devices and components/units thereof in the system (100) may be implemented in software, hardware, or a combination of software and hardware, with one or more of: computing processors such as central processing units or CPUs, audio codecs, video codecs, digital signal processors, graphic processing units or GPUs, etc.

The system environment (100) includes three or more (e.g., video, audiovisual, etc.) communication client devices 102-1, 102-2, . . . , 102-N (where N is an integer no less than 3), a (e.g., video, audiovisual, etc.) communication server 104, etc. The communication client devices (102-1, 102-2, . . . 102-N) are operatively linked or connected with the communication server (104) through three or more network data connections 106-1, 106-2, . . . , 106-N, respectively. These network data connections (106-1, 106-2, . . . , 106-N) can be supported with one or more (e.g., wired, wireless, satellite based, optical, etc.) networks or communication services available to the communication client devices (102-1, 102-2, . . . 102-N) and the communication server (104).

Example communication client devices may include, but are not necessarily limited to only, mobile computing devices such as mobile phones, smartphones, tablet computers, laptop computers, desktop computers, computers operating with separate (e.g., relatively large screen, etc.) image display devices, etc. Each of the communication client devices (102-1, 102-2, . . . 102-N) implements—or controls/operates with one or more attendant devices that implement-real time or near real time video and/or audio capturing functionality/capability and rendering functionality/capability. In some operational scenarios, each of the communication client devices (102-1, 102-2, . . . 102-N) is situated or deployed at a different or distinct location from other locations of the others of the communication client devices (102-1, 102-2, . . . 102-N). In some operational scenarios, at least two of the communication client devices (102-1, 102-2, . . . 102-N) are situated or deployed at the same location.

Three or more users respectively operate the communication client devices (102-1, 102-2, . . . 102-N) to (e.g., real time, near real time, remotely, computer network enabled, etc.) communicate or telecommunicate with one another during a time interval or communication (or teleconference) session. While the users do not directly or actually look at one another (e.g., they do not look at one another in person, etc.), these users can nevertheless virtually visually interact one another under techniques as described herein.

For example, each (e.g., 102-N, etc.) of the communication client devices (102-1, 102-2, . . . 102-N) is operated by a respective user of the three or more users to view rendered images of the communication session on an image display operating in conjunction with the communication client device (102-N in the present example). The rendered images depict some or all of the others of the three or more users operating some or all (e.g., 102-1, . . . 102-(N-1) (not shown), etc.) of the others of the communication client devices (102-1, 102-2, . . . 102-N).

Under some approaches as illustrated in FIG. 1B, in which the rendered images contain visual depictions of users or participants as captured from cameras, there may exist a normal single camera problem. More specifically, as shown in FIG. 1B, a first user “Paul” may be looking at a visual depiction of a first other user “Shwertha” among two other users depicted on Paul's image display. As captured by a camera (denoted as “Real camera”) operated by Paul, a visual depiction of Paul may indicate that Paul is looking down left. This original or camera-captured visual depiction of Paul may be sent directly or indirectly by Paul's communication client device to other communication client devices of the other users, namely Shwetha and a second other user “Nikhil”. As shown, in both image displays operated by Shwetha and Nikhil, Paul is indicated by his camera captured visual depictions as looking down left. With this visual depiction of Paul on their image displays, everyone among the other users has a wrong view of Paul.

In contrast, under techniques as described herein, these rendered images can be generated, adapted and/or modified from original camera captured image portions captured by cameras operating with the other communication client devices (102-1, . . . 102-(N-1) in the present example). In some operational scenarios, as illustrated in FIG. 1C, the original camera captured image portions can be carried or encoded in image streams (or sub-streams) originated from the other communication client devices (102-1, . . . 102-(N-1) in the present example) and delivered to the communication client device (102-N in the present example) by way of the image streams or by way of an overall image stream (e.g., generated by the communication server (104)) encapsulating the image streams.

Hence, the image streams and/or the original camera captured image portions therein may be directly or indirectly received by the communication client device (102-N in the present example) from the other communication client devices (102-1, . . . 102-(N-1) in the present example). As shown in FIG. 1C, two original captured image portions or visual depictions 132-1 and 132-2 of two users may be captured by respective (e.g., real, etc.) cameras operating in conjunction with the communication client devices (102-1 and 102-2). The visual depictions (132-1 and 132-2) can may be directly or indirectly received by the communication client device (102-N) from the communication client devices (102-1 and 102-2) over one or more networks 136, for example by way of the communication server (104).

In addition, while the cameras operating with the other communication client devices (102-1, . . . 102-(N-1) in the present example) are capturing the original camera captured image portions depicting the other users operating these other communication client devices, gaze trackers respectively operating with the other communication client devices (102-1, . . . 102-(N-1) in the present example) are concurrently or contemporaneously capturing respective eye gaze data portions of these other users. The respective eye gaze data portions may indicate respective gaze directions of these other users.

The gaze data portions can be carried or included, for example as metadata, in the same image streams (or sub-streams) originated from the other communication client devices (102-1, . . . 102-(N-1) in the present example) and delivered to the communication client device (102-N in the present example) by way of the image streams or by way of an overall image stream (e.g., generated by the communication server (104)) encapsulating the image streams.

Additionally, optionally or alternatively, the gaze data portions can be carried or included in different data streams (or sub-streams) separate from the image streams (or sub-streams) originated from the other communication client devices (102-1, . . . 102-(N-1) in the present example) and delivered to the communication client device (102-N in the present example) by way of the separate data streams or by way of an overall data stream (e.g., generated by the communication server (104)) encapsulating the data streams respectively containing the gaze data portions captured with the other communication client devices (102-1, . . . 102-(N-1) in the present example).

By way of illustration but not limitation, the respective eye gaze data portions may include a specific eye gaze data portion of a second specific user-among the other users-operating a second specific communication client device (e.g., 102-1, etc.) among the other communication client devices (102-1, . . . 102-(N-1) in the present example).

Second rendered images may be displayed on a second image display operating with the second specific communication client device (102-1 in the present example). The second rendered images may include image portions depicting the respective user operating the specific communication client device (102-N in the present example) as well as the remaining users of the other users operating the remaining communication client devices (102-2, . . . 102-(N-1)) in the present example).

The specific eye gaze data portion of the second specific may be generated or derived from raw eye gaze data collected from an eye gaze tracker operating with the second communication client device (102-1 in the present example) to indicate a particular user—or a particular image portion in the second rendered images visually representing the particular user—at which the second specific user is gazing or viewing. Here, the particular user may be one of a set of users formed by the respective user operating the specific communication client device (102-N in the present example) as well as the remaining users of the other users operating the remaining communication client devices (102-2, . . . 102-(N-1)) in the present example).

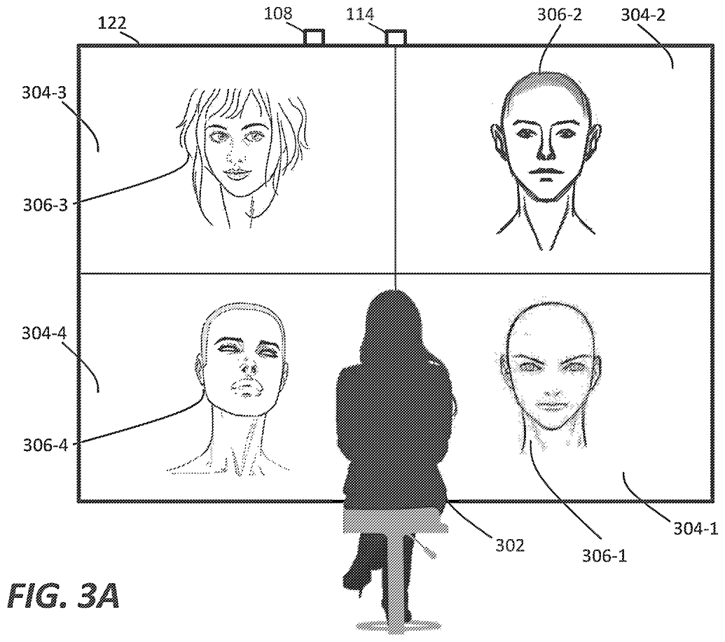

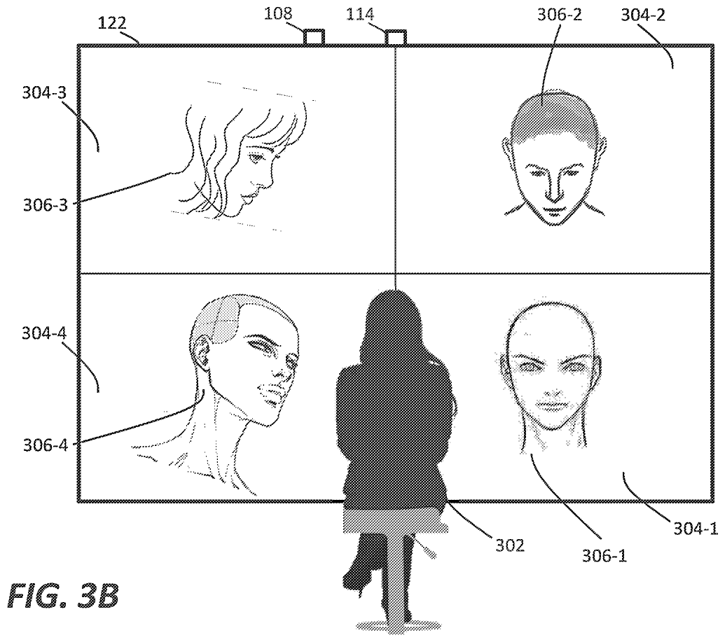

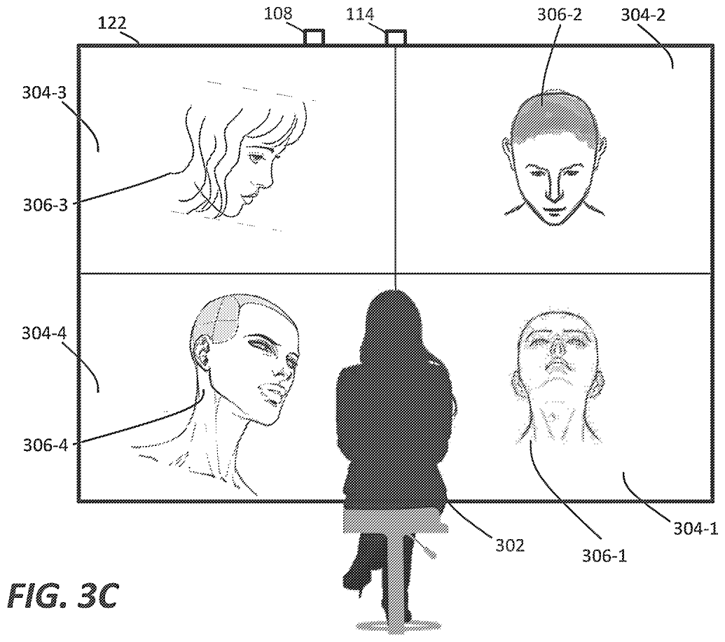

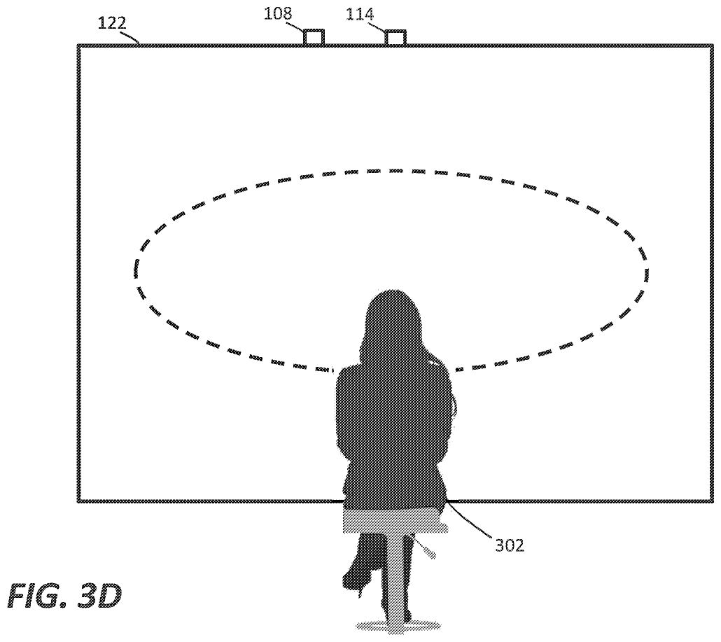

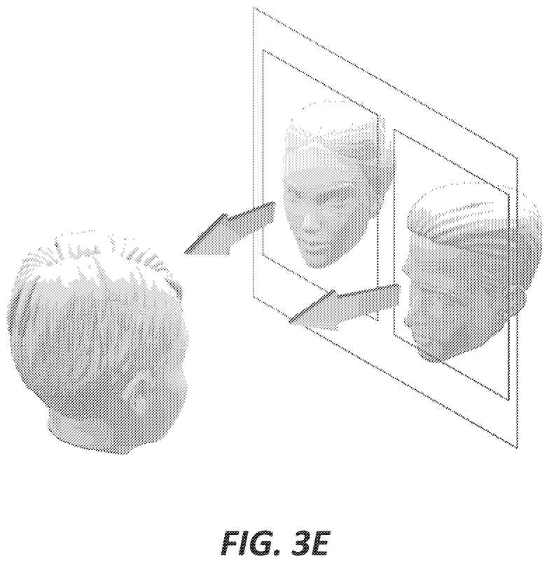

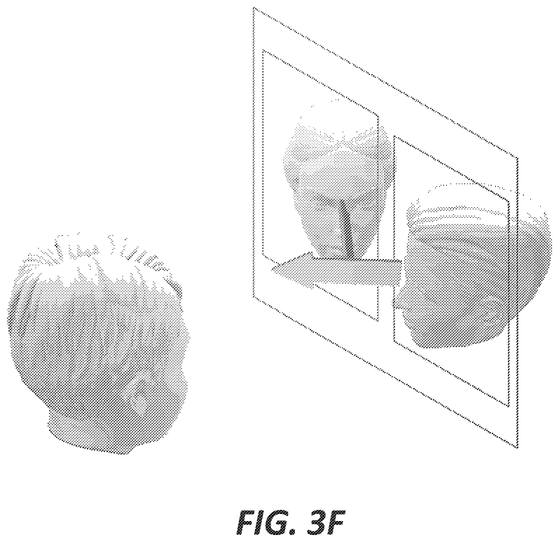

The specific eye gaze data portion indicating that the second specific user is gazing or viewing at the particular user may be communicated or provided—e.g., by way of the image streams or separate data streams or overall image/data stream(s)—to the specific communication client device (102-N in the present example) as well as to the remaining communication client devices (102-2, . . . 102-(N-1) in the present example). As shown in FIG. 3C, the original visual depictions (132-1 and 132-2) of the two users can be received and modified by the receiving communication client device (102-N) into modified or adapted visual depictions 134-1 and 134-2, respectively, of the two users. The modified or adapted visual depictions (134-1 and 134-2) can be rendered on an image display operating with the receiving communication client device (102-N), instead of the original visual depictions (132-1 and 132-2) of the two users.

In a first example, the specific eye gaze data portion indicates that the second specific user (operating the second specific communication client device (102-1) in the present example) is gazing or viewing at the particular user, who is operating the particular communication client device (102-2).

In response to receiving the specific eye gaze data portion indicating that the second specific user is gazing or viewing at the particular user (operating the particular communication client device (102-2) in the present example) as well as receiving a specific original camera captured image portion (captured by a second camera operating with the second specific communication client device 102-1 in the present example) depicting the second specific user, the specific communication client device (102-N in the present example) can adapt or warp the specific original camera captured image portion (captured by the second camera operating with the second specific communication client device 102-1 in the present example) depicting the second specific user to indicate on the rendered images on the image display operating with the specific communication client device (102-N in the present example) that the face, the head and/or the gaze of the second specific user in the rendered images is/are turning toward an image portion—in the same rendered images-depicting the particular user (operating the particular communication client device (102-2) in the present example).

In a second example, the specific eye gaze data portion indicates that the second specific user (operating the second specific communication client device (102-1) in the present example) is gazing or viewing at the particular user, who is the same as the specific user operating the specific communication client device (102-N in the present example).

In response to receiving the specific eye gaze data portion indicating that the second specific user is gazing or viewing at the specific user operating the specific communication client device (102-N in the present example) as well as receiving the specific original camera captured image portion (captured by the second camera operating with the second specific communication client device 102-1 in the present example) depicting the second specific user, the specific communication client device (102-N in the present example) can render the received specific original camera captured image portion without adaptation or warping. Additionally, optionally or alternatively, instead of rendering the received specific original camera captured image portion without adaptation or warping, the specific communication client device (102-N in the present example) can adapt or warp the received specific original camera captured image portion to indicate or depict that the second specific user is gazing out of the image display operating with the specific communication client device (102-N in the present example) toward the specific user sitting in front of the image display.

FIG. 1D illustrates an example communication client device 102 (e.g., any of 102-1 through 102-N of FIG. 1A, etc.). The system (102) can be implemented with one or more computing devices and operated by a user in a communication session with enhanced remote visual interaction. The one or more computing devices comprise any combination of hardware and software implementing various components, including but not necessarily limited to only: a gaze tracker interface 110, a camera interface 116, a gaze data communicator 112, an image stream communicator 118, an interactive image generator 120, and so on.

The communication client device (102) or the gaze tracker interface (110) therein may receive or collect real time or near real time gaze tracker data from one or more gaze trackers 108 operatively linked with the communication client device (102) over one or more internal or external data connections. The collected gaze tracker data may indicate, with little latency (e.g., one millisecond, five millisecond, within a strict time budget, etc.), real time or near real time gaze directions of a user operating the communication client device (102). The communication client device (102) or the gaze tracker interface (110) can use the collected gaze tracker data to determine a specific (gazed) spatial location-on an image display 120 operating with the communication client device (102)—at which the user is currently looking or viewing. The communication client device (102) or the gaze tracker interface (110) can then use the specific spatial location as determined from the gaze tracker data to determine a specific (gazed) image portion of a rendered image displayed on the image display (120) and to derive a specific (gazed) visually represented user depicted in the specific image portion of the rendered image displayed on the image display (120). Some or all of the gaze tracker data, information identifying the specific (gazed) spatial location, information identifying the specific (gazed) image portion, information identifying the specific (gazed) visually represented user may be provided by the gaze tracker interface (110) to the gaze data communicator (112).

The communication client device (102) or the gaze data communicator (112) therein may exchange or communicate (real time or near real time) gaze data 124 with other communication client devices in the same communication session. In a first example, the communication client device (102) and the other communication client devices may implement a peer-to-peer model to exchange the gaze data (124) directly with one another. In a second example, the communication client device (102) and the other communication client devices may implement a master slave model to exchange the gaze data (124) indirectly with one another through a master communication client device among the communication client device (102) and the other communication client devices. The master communication client device may be elected or designated among these communication client devices. In a third example, the communication client device (102) and the other communication client devices may communicate through a communication server (e.g., 104 of FIG. 1A, etc.) and exchange the gaze data (124) indirectly with one another through th communication server (104).

Hence, a gaze data portion (in the gaze data (124)) indicating the specific visually represented user-on the rendered image displayed on the image display (120) at which the user operating the communication client device (102) is gazing or viewing may be sent by the communication client device (102) or the gaze data communicator (112) therein to the other communication client devices.

In the meantime, other gaze data portions (in the gaze data (124)) indicating other visually represented users-on other rendered images displayed on other image displays operating with the other communication client devices—at which other users operating the other communication client devices are respectively gazing or viewing may be received by the communication client device (102) or the gaze data communicator (112) therein from the other communication client devices.

The communication client device (102) or the camera interface (116) therein may receive or collect real time or near real time camera captured image data from one or more cameras 114 operatively linked with the communication client device (102) over one or more second internal or external data connections. The collected camera image data may contain a specific image portion visually depicting the user operating the communication client device (102) in real time or near real time. The camera image data or the specific image portion therein may be provided by the camera interface (116) to the image stream communicator (118).

The communication client device (102) or the image stream communicator (118) therein may exchange or communicate (real time or near real time) camera (captured) image portions as image stream data 126 with other communication client devices in the same communication session. These camera captured image portions (in the image stream data (126)) respectively depict some or all of the users operating the communication client device (102) and the other communication client devices. In a first example, the communication client device (102) and the other communication client devices may implement a peer-to-peer model to exchange the camera captured image portions (in the image stream data (126)) directly with one another. In a second example, the communication client device (102) and the other communication client devices may implement a master slave model to exchange the camera captured image portions (in the image stream data (126)) indirectly with one another through a master communication client device among the communication client device (102) and the other communication client devices. In a third example, the communication client device (102) and the other communication client devices may communicate through a communication server (e.g., 104 of FIG. 1A, etc.) and exchange the camera captured image portions (in the image stream data (126)) indirectly with one another through th communication server (104).

Hence, the camera captured image portion (in the image stream data (126)) depicting the user operating the communication client device (102) may be sent by the communication client device (102) or the image stream communicator (118) therein to the other communication client devices.

In the meantime, other camera captured image portions (in the image stream data (126)) depicting other visually represented users may be received by the communication client device (102) or the image stream communicator (118) therein from the other communication client devices.

The communication client device (102) or the interactive image generator (120) therein may implement or perform real time or near real time artificial intelligence (AI) or machine learning (ML) operations (e.g., algorithms, methods, processes, predictive models, etc.) for enhancing remote visual interaction in the communication session. The AI/ML operations can be performed by the interactive image generator (120) in real time or near real time to determine spatial positions of some or all visually depicted users in the rendered image displayed on the image display (122). The interactive image generator (120) can use the spatial positions of the visually depicted users determined for the rendered image on the image display (122) and the other gaze data portions received from the other communication client devices to modify or adapt the camera captured image portions respectively depicting the other users to generate modified or enhanced image portions respectively depicting the other users.

In a first example, in response to determining that a first user corresponding to a first visually depicted user is gazing at a second visually depicted user on a first image display operated by the first user, where the second visually depicted user is also visually depicted on the image display (122), the interactive image generator (120) can modify or adapt a first camera captured image portion-among the camera captured image portions-into a first modified or enhanced image portion among the modified or enhanced image portions such that the first modified or enhanced image portion is directing attention (e.g., via head or eye gaze direction, etc.) toward the second visually depicted user.

In a second example, in response to determining that the first visually depicted user is gazing at a visually depicted user on the first image display operated by the second user, where the visually depicted user corresponds to the user operating the communication client device (102), the interactive image generator (120) can modify or adapt a first camera captured image portion-among the camera captured image portions-into a second modified or enhanced image portion among the modified or enhanced image portions such that the second modified or enhanced image portion is directing attention (e.g., via head or eye gaze direction, etc.) toward the user out of the image display (122).

### 3. Predictive Models for Enhancing Remote Visual Interactions

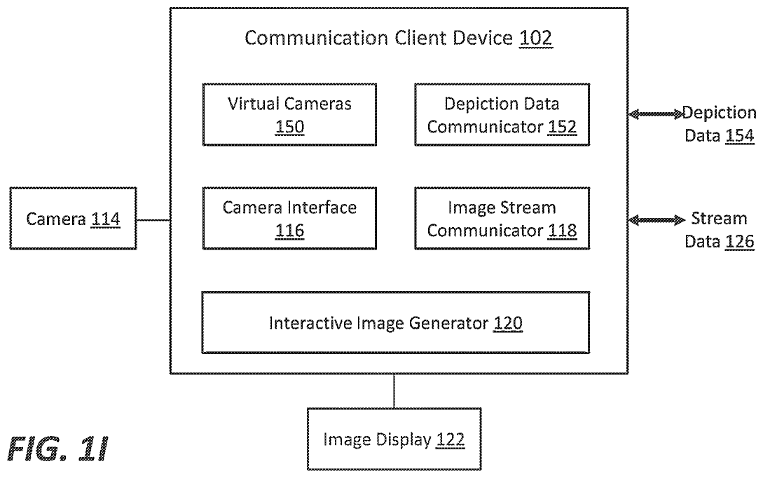

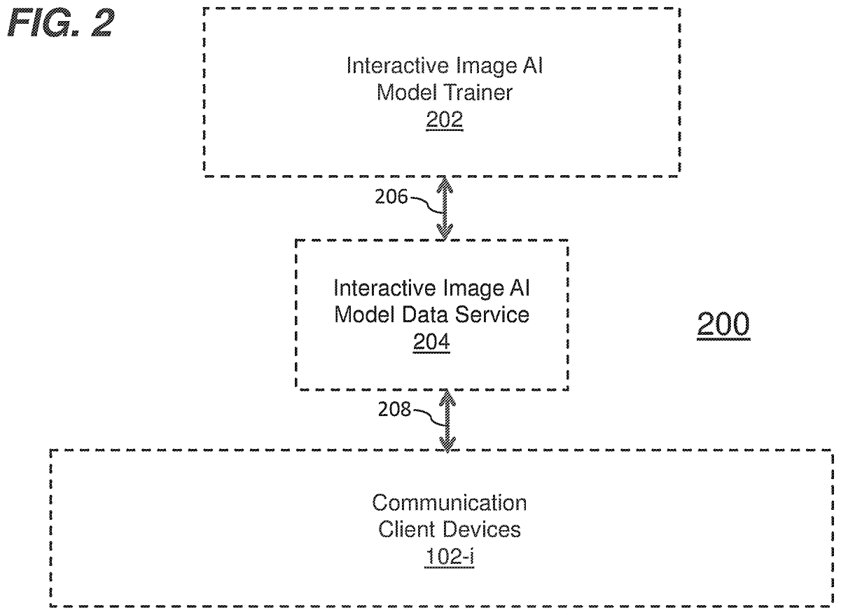

FIG. 2 is an example AI/ML framework 200 for enhancing remote visual interaction in computer network enabled communications. The AI/ML framework (200) includes a (e.g., cloud-based, non-cloud-based, etc.) interactive image AI model trainer 202, a (e.g., cloud-based, non-cloud-based, etc.) interactive image AI model data service 204, a population of communication client devices 102-i (e.g., 102 of FIG. 1D, 102-1, 102-2, . . . 102-N of FIG. 1A, etc.), etc. Each device or system in the AI/ML framework (200) may be implemented with one or more computing devices that comprise any combination of hardware and software implementing various logical components described herein.

The interactive image AI model trainer (202), the interactive image AI model data service (204) and the population of communication client devices (102-i) may communicate with one another directly or indirectly over one or more first network data connections 206, one or more second network data connections 208, and so forth. Example network data connections may include, but are not necessarily limited to, one or more of: wireless and/or wired connections, optical data connections, etc.

The population of communication client devices (102) may be of multiple different types. Each communication client device in some or all of the communication client devices (102) may be installed or deployed with one or more AL/ML models for enhancing remote visual interaction.

Each communication client device in some or all of the communication client devices (102) may be installed or deployed with model data collection functionality to collect AI/ML client data including but not necessarily limited to only: eye gaze data of user(s) and camera captured image portions depicting the user(s). For example, the collected AI/ML client data may include camera captured image portions depicting a specific user at various (e.g., head, body, etc.) orientations and/or (e.g., head, body, etc.) positions. Additionally, optionally or alternatively, the collected AI/ML client data may include synchronized or contemporaneous eye gaze data indicating the user's gaze or viewing directions correlated with the specific user's (e.g., head, body, etc.) orientations and/or (e.g., head, body, etc.) positions at which the specific user is currently gazing or viewing.

In some operational scenarios, some or all of the collected AI/ML client data generated by some or all communication client devices in the population of communication client devices (102-i) may be uploaded or communicated to the interactive image AI model trainer (202), for example by way of the interactive image AI model data service (204). The interactive image AI model trainer (202) may generate training data for enhancing remote visual interaction. The training data may include labeled AI/ML data generated based at least in part on the received AI/ML client data from the population of communication client devices (102-i).

As used herein, “labeled AI/ML data” refers to AI/ML client data labeled with ground truth such as an image portion depicting a user with labels or ground truth identifying the user, a contemporaneous viewing direction (e.g., a front direction, a direction tilted toward a specific angle, etc.) at which the depicted user is currently gazing or viewing at the time the image portion is captured by a camera, etc.

The interactive image AI model trainer (202) may implement AI and/or ML algorithms, methods, models, etc., for enhancing remote visual interaction. The training data such as labeled AI/ML data from the population of communication client devices (102-i) and/or other training data sources can be used by the interactive image AI model trainer (202) to train and/or test the AI and/or ML algorithms, methods, models, etc. An AI/ML (predictive) model as described herein may be implemented with artificial neural networks (or NN) such as based on TensorFlow, with non-neural-network techniques, with a generative model in which operational parameters are continuously, iteratively or recursively trained with training data. The AI/ML model may be designed to use features/tensors of various feature/tensor types extracted or derived from gaze data and/or camera captured image portions depicting users to generate predicted image portions depicting the users at various orientations and/or positions.

In a model training phase implemented by the interactive image AI model trainer (202), predicted image portions depicting the users at various orientations and/or positions can be compared with labeled image portions depicting the users at the same orientations and/or positions to estimate or measure prediction errors based at least in part on objective functions, cost function, error functions, distance functions, etc.

Optimized values for operational parameters (e.g., biases, weights, etc.) of the AI/ML model may be obtained by minimizing some or all of the prediction errors (e.g., through back propagation of prediction errors, etc.).

The optimized values for the operational parameters for the AI/ML model may be downloaded or communicated to the population of communication client devices (102-i), for example by way of the interactive image AI model data service (204).

In a model application phase, each of some or all communication client devices in the population of communication client devices (102-i) may apply the trained AI/ML model with the optimized values for the operational parameters to use features/tensors—of the same feature/tensor types used in training-extracted or derived from gaze data and/or camera captured image portions depicting a specific user to generate predicted image portions depicting the specific user at specific orientations and/or positions to indicate or enhance remote visual interaction.

For example, based at least in part on a camera captured image portion depicting the specific user at a given time point and synchronized gaze data indicating a contemporaneous viewing direction of the specific user at the given time point as received from a specific communication client device operating by the specific user, a communication client device in the same communication session can modify or adapt the received camera generated image portion to a modified or adapted image portion (e.g., a non-camera-generated image, etc.) depicting the specific user as orienting toward another image portion depicting a second specific user, in response to determine that the contemporaneous gaze data indicates the specific user is gazing or viewing the second specific user as visually represented in an image display operated by the specific user.

Additionally, optionally or alternatively, in a model training phase implemented by the interactive image AI model trainer (202), one or more AI/ML predictive models may be trained with training data to estimate or predict some or all: depth information from texture information of an image, detecting bounding boxes or regions for faces, placing face meshes on detected faces, predicting mid-points of interpupil distances for detected faces, etc. In a model application phase, each of some or all communication client devices in the population of communication client devices (102-i) may apply the trained AI/ML models with the optimized values for the operational parameters to use features/tensors—of the same feature/tensor types used in training-extracted or derived from g camera captured image portions depicting a specific user, rendered images, visual depiction data, etc., from other communication counterparts such as from a communication server or other communication clients to generate some or all of: depth information from texture information of an image, detecting bounding boxes or regions for faces, placing face meshes on detected faces, predicting mid-points of interpupil distances for detected faces, etc.

### 4. Visual Depictions of Users

FIG. 3A illustrates a first example rendered image rendered at a first time point in a communication session on an image display 122 to a first user 302. The first user (302) operates the image display (122) and a communication client device to conduct real time or near real time audiovisual communication (e.g., within 5 millisecond latency or delay, within 10 millisecond latency or delay, etc.) with two or more other users operating their respective image displays and communication client devices in the same communication session.

A user (e.g., 302, any of some or all of the two or more other users, etc.) in the communication session may see other users through real time or near real time video images rendered on an image display operating in conjunction with a communication client device used by the user; these real time or near real time video images depict the other users in real time or near real time. The user may hear other users through real time or near real time audio sounds rendered by audio speakers or earphones operating in conjunction with the communication client device. The user may speak to other users through real time or near real time audio signals captured by audio capturing devices/sensors operating in conjunction with the communication client device. The captured audio signals may be provided to other communication client devices operated by the other users in one or more audio streams, for example by way of a communication server such as 104 of FIG. 1A. Audio speakers or earphones operating in conjunction with the other communication client devices may reproduce or render audio sounds from the received audio signals originated or provided from the communication client device.

A rendered image may be partitioned or divided into a plurality of different image portions located in different spatial regions/locations of a (e.g., real, virtual, etc.) display screen of the image display (122). As shown, the first rendered image of FIG. 3A as rendered to the first user (302) at the first time point is partitioned or divided into four image portions 306-1 through 306-4, which are respectively located in four different spatial regions/locations 304-1 through 304-4 of the display screen in a grid layout.

Each of the image portions (306-1 through 306-4) visually depicts a respective user of the two or more other users in the communication session at the first time point. For example, the image portion (306-1) depicts a first other user at the first time point. The image portion (306-2) depicts a second other user at the first time point. The image portion (306-3) depicts a third other user at the first time point. The image portion (306-4) depicts a fourth other user at the first time point.

The communication client device (e.g., one of 102-1 through 102-N of FIG. 1A, 102 of FIG. 1D, etc.) operating in conjunction with the image display (122) is in direct and/or indirect communication with two or more other communication client devices (e.g., two or more of some or all others of 102-1 through 102-N of FIG. 1A, 102 of FIG. 1D, etc.) respectively operated by the two or more other users. Each of all these communication client devices operates with one or more gaze trackers and/or one or more cameras to generate or collect respective eye tracker data and camera-captured image portions relating to or depicting a user operating the communication client device.

As illustrated in FIG. 3A, the communication client device operated by the first user (302) includes, or operates with, a gaze tracker 108 and a camera 114 to generate or collect eye tracker data and camera-captured image portions relating to or depicting the first user (302) operating the communication client device. The camera-captured image portions visually depict the first user (302) at various time points in the communication session, whereas the eye tracker data indicate viewing/gazing directions of the first user (302) contemporaneous or synchronized with the camera-captured image portions.

A communication client device as described herein may use eye tracker data to generate tracking data to indicate specific users—or specific image portions or specific spatial regions/locations of a display screen of an image display (e.g., 122, etc.) depicting specific users—at which a user operating the communication client device is viewing or gazing at the various time points.

For example, the communication client device operated by the first user (302) can use the eye tracker data collected from the eye tracker 108 to generate a first portion of tracking data to indicate any specific user—or a specific image portion or spatial region/location of the display screen of the image display (122)—at which the first user (302) is viewing or gazing at the first time point. The tracking data including but not limited to the first portion for the first time point, with or without a camera captured image portion depicting the first user (302) at the first time point, may be sent by the communication client device to the communication server (104 of FIG. 1A) and/or to the two or more other communication client devices, for example by way of the communication server (104 of FIG. 1A).

Another client communication device such as any or one of the two or more other communication client devices, in response to receiving the tracking data portion, can modify or adapt a concurrently or previously received image portion depicting the first user (302) through (e.g., AI/ML based, non-AI/ML based, etc.) image warping to generate a (non-camera-captured) modified or adapted image portion depicting the first user (302) as orienting or directing attention to the specific user, which is indicated by the tracking data portion as being gazed at, focused, or viewed by the first user (302) at the first time point. The modified or adapted image portion may be rendered (e.g., for the next time point, for a subsequent time point, etc.) by the other communication client device on another image display (other than 122 of FIG. 3A) operating with the other communication client device to visually depict the first user (302) on the other image display.

It should be noted that the image warping performed to generate the modified or adapted image portion depicting the first user (302) may take into account a first spatial region/location on the other image display currently assigned to display or rendered the modified or adapted image portion depicting the first user (302) as well as take into account a second spatial region/location on the other image display currently assigned to display or rendered image portions depicting the specific user at which the first user (302) is gazing at or viewing on the image display (122).

The communication client device operated by the first user (302) can receive respective tracking data portion(s) to indicate a second specific user—or a second specific image portion or spatial region/location of a display screen of another image display operated by the other user—at which each other user of the two or more other users is viewing or gazing at a given time point.

The client communication device operated by the first user (302), in response to receiving the respective tracking data portion(s), can modify or adapt a concurrently or previously received image portion depicting the each other user through (e.g., AI/ML based, non-AI/ML based, etc.) image warping to generate a (non-camera-captured) modified or adapted image portion depicting the each other user as orienting or directing attention to the second specific user, which is indicated by the respective tracking data portion as being gazed at, focused, or viewed by the each other user at the given time point. The modified or adapted image portion may be rendered by the communication client device on the image display (122) to visually depict the each other user.

It should be noted that the image warping performed to generate the modified or adapted image portion depicting the each other user on the image display (122) may take into account a first spatial region/location on the image display (122) currently assigned to display or rendered the modified or adapted image portion depicting the each other user as well as take into account a second spatial region/location on the image display (122) currently assigned to display or rendered image portions depicting the second specific user at which the each other user is gazing at or viewing on another image display operated by the each other user.

For the purpose of illustration only, for the first time point, the two or more other users may be indicated by their respective tracking data portions received by the communication client device operated by the first user (302) as gazing at or viewing the first user (302) or image portions depicting the first user (302) on their respective image displays. In response, the communication client device may can modify or adapt concurrently or previously received image portions depicting the two or more other users through (e.g., AI/ML based, non-AI/ML based, etc.) image warping to generate (non-camera-captured) modified or adapted image portions depicting the two or more other users as orienting or directing attention to the first user (302), which is indicated by the tracking data portions received by the communication client device operated by the first user (302). The modified or adapted image portions may be rendered by the communication client device on the image display (122) to visually depict the two or more other users as viewing out of the display screen of the image display (108) to gaze at or view the first user (302) at the first time point. This is also illustrated in FIG. 3E, which shows two users as visually depicted on an image display gazing out of the image display toward—as indicated by two arrows pointing at—a viewer or user to which the visual depictions of the two users are rendered on the image display.

In some operational scenarios, a user at various angles in a solid angle (e.g., 360 degrees times 180 degrees, a front facing solid angle portion, etc.) may be captured or prestored in camera captured images or image portions before the communication session. Predictions—or AI or ML based image warping—of visual representations or image portions may be performed with an AI or ML image prediction model trained with training data. The training data may comprise training images at different view angles for different users in a population of users. The training data may or may not include the camera captured images of users who are present in the communication session.

AI or ML based image warping may use a view direction of a user and an available visual representation or image portion of a possibly different view direction to predict or generate a visual representation or image portion of the user with the view direction. The AI or ML image prediction model may be trained with the training data to minimize prediction errors and then deployed in communication client devices to effectuate AI or ML based image warping.

Additionally, optionally or alternatively, in some operational scenarios, image warping may not be AI or ML based. For example, a user at various angles in a solid angle (e.g., 360 degrees times 180 degrees, a front facing solid angle portion, etc.) may be captured or prestored in images or image portions before the communication session. These images or image portions can be indexed or keyed with viewing directions and selected based on view directions of the user in the communication session.

A view direction of the user may be computed for another user's image display using a combination of real time or near real time view direction to the user's image display as measured or determined with eye gaze tracking and a spatial regions/location of a specific user (on the other user's image display) to which the user is viewing or gazing on the user's image display. The view direction can be used to find a visual representation or image portion(s) of the user with a matched view (or a matched index or key value).

If no exact match can be found, visual representation(s) or image(s) with closest matching viewing direction(s) may be selected and blend, mixed or interpolated into a visual representation or image portion with the view direction.

The visual representation or image portion of the user with the view direction can be rendered on the other user's image display to indicate whether the user is looking toward or away from the specific user.

For the purpose of illustration only, 2D visual representations of users or participants in a communication session has been used to illustrate some embodiments. It should be noted, however, that 3D visual representations of users or participants may be used or rendered in a communication session as described herein in some operational scenarios. For example, in addition to using view directions and/or (e.g., 2D, etc.) positions of users or participants, 3D positional and/or directional information including but not depth information acquired with depth cameras/sensors operating with communication client devices may be used to generate stereoscopic (using AI/ML based methods and/or using non-AI/non-ML based methods), 3D or multiview visual depictions of users or participants in a communication session as described herein. For example, an AI/ML 3D image predictive model may be trained with training data including but not limited to visual representations or images with various 3D positional and/or directional information and deployed to predict 3D or multiview visual depictions of users or participants in a communication session as described herein. The predicted 3D or multiview visual depictions of users or participants can then be rendered or displayed to other users or participants.

For the purpose of illustration only, real time or near real time communication sessions have been used to illustrate some embodiments. It should be noted, however, that some or all techniques as described may be used for non-real-time communication sessions such as pre-recorded webinars or conferences or other audiovisual programs in some operational scenarios.

FIG. 3B illustrates a second example rendered image rendered at a second time point in the communication session on the image display (122) to the first user (302).

As shown, the second rendered image of FIG. 3B as rendered to the first user (302) at the second time point is partitioned or divided into four image portions 306-1 through 306-4 (which contain different image content from those of the first image at the first time point as illustrated in FIG. 3A), which are respectively located in the spatial regions/locations (304-1 through 304-4) of the display screen in the same grid layout as illustrated in FIG. 3A.

Each of the image portions (306-1 through 306-4) visually depicts a respective user of the two or more other users in the communication session at the second time point. For example, the image portion (306-1) depicts the first other user at the second time point. The image portion (306-2) depicts a second other user at the second time point. The image portion (306-3) depicts a third other user at the second time point. The image portion (306-4) depicts a fourth other user at the second time point.

For example, the communication client device operated by the first user (302) can use the eye tracker data collected from the eye tracker 108 to generate a second portion of tracking data to indicate any specific user—or a specific image portion or spatial region/location of the display screen of the image display (122)—at which the first user (302) is viewing or gazing at the second time point. The tracking data including but not limited to the second portion for the second time point, with or without a camera captured image portion depicting the first user (302) at the second time point, may be sent by the communication client device to the communication server (104 of FIG. 1A) and/or to the two or more other communication client devices, for example by way of the communication server (104 of FIG. 1A).

Another client communication device such as any or one of the two or more other communication client devices, in response to receiving the second tracking data portion, can modify or adapt a concurrently or previously received image portion depicting the first user (302) through (e.g., AI/ML based, non-AI/ML based, etc.) image warping to generate a (non-camera-captured) modified or adapted image portion depicting the first user (302) as orienting or directing attention to the specific user, which is indicated by the tracking data portion as being gazed at, focused, or viewed by the first user (302) at the second time point. The modified or adapted image portion may be rendered (e.g., for the next time point, for a subsequent time point, etc.) by the other communication client device on another image display (other than 122 of FIG. 3A) operating with the other communication client device to visually depict the first user (302) on the other image display.

As noted herein, the communication client device operated by the first user (302) can receive respective tracking data portion(s) to indicate a second specific user—or a second specific image portion or spatial region/location of a display screen of another image display operated by the other user—at which each other user of the two or more other users is viewing or gazing at a given time point.

The client communication device operated by the first user (302), in response to receiving the respective tracking data portion(s), can modify or adapt a concurrently or previously received image portion depicting the each other user through (e.g., AI/ML based, non-AI/ML based, etc.) image warping to generate a (non-camera-captured) modified or adapted image portion depicting the other user as orienting or directing attention to the second specific user, which is indicated by the respective tracking data portion as being gazed at, focused, or viewed by the each other user at the given time point. The modified or adapted image portion may be rendered by the communication client device on the image display (122) to visually depict the each other user.

For the purpose of illustration only, for the second time point, the second, third and fourth other users may be indicated by their respective tracking data portions received by the communication client device operated by the first user (302) as gazing at or viewing the first other user or image portions depicting the first other user on respective image displays operated by the second, third and fourth other users. In response, the communication client device may can modify or adapt concurrently or previously received image portions depicting second, third and fourth other users through (e.g., AI/ML based, non-AI/ML based, etc.) image warping to generate (non-camera-captured) modified or adapted image portions depicting the second, third and fourth other users as orienting or directing attention to the first other user, which is indicated by the tracking data portions received by the communication client device operated by the first user (302). The modified or adapted image portions may be rendered by the communication client device on the image display (122) to visually depict the second, third and fourth other users as viewing within the display screen of the image display (108) to gaze toward the first other user at the second time point.

In addition, for the second time point, the first other user may be indicated by a respective tracking data portion received by the communication client device operated by the first user (302) as gazing at or viewing the first user (302) or image portions depicting the first user (302) on a respective image display operated by the first other user. In response, the communication client device may can modify or adapt a concurrently or previously received image portion depicting the first other user through (e.g., AI/ML based, non-AI/ML based, etc.) image warping to generate a (non-camera-captured) modified or adapted image portion depicting the first other user as orienting or directing attention to the first user (302), which is indicated by the tracking data portion received by the communication client device operated by the first user (302). The modified or adapted image portion may be rendered by the communication client device on the image display (122) to visually depict the first other user as viewing out of the display screen of the image display (108) to gaze at or view the first user (302) at the second time point.

FIG. 3C illustrates a third example rendered image rendered at a third time point in the communication session on the image display (122) to the first user (302).

For the purpose of illustration only, for the third time point, the second, third and fourth other users may be indicated by their respective tracking data portions received by the communication client device operated by the first user (302) as gazing at or viewing the first other user or image portions depicting the first other user on respective image displays operated by the second, third and fourth other users. In response, the communication client device may can modify or adapt concurrently or previously received image portions depicting second, third and fourth other users through (e.g., AI/ML based, non-AI/ML based, etc.) image warping to generate (non-camera-captured) modified or adapted image portions depicting the second, third and fourth other users as orienting or directing attention to the first other user, which is indicated by the tracking data portions received by the communication client device operated by the first user (302). The modified or adapted image portions may be rendered by the communication client device on the image display (122) to visually depict the second, third and fourth other users as viewing within the display screen of the image display (108) to gaze toward the first other user at the third time point.

In addition, for the third time point, the first other user may be indicated by a respective tracking data portion received by the communication client device operated by the first user (302) as gazing at or viewing the second other user or image portions depicting the second other user on the respective image display operated by the first other user. In response, the communication client device may can modify or adapt a concurrently or previously received image portion depicting the first other user through (e.g., AI/ML based, non-AI/ML based, etc.) image warping to generate a (non-camera-captured) modified or adapted image portion depicting the first other user as orienting or directing attention to the second other user, which is indicated by the tracking data portion received by the communication client device operated by the first user (302). The modified or adapted image portion may be rendered by the communication client device on the image display (122) to visually depict the first other user as viewing within the display screen of the image display (108) to gaze toward the second other user at the third time point, while the second other user is visually depicted in the same rendered image as viewing within the display screen of the image display (108) to gaze toward the first other user at the same third time point. FIG. 3F illustrates another example rendered image on an image display operated or viewed by a user. Instead of gazing out of the image display toward the user as illustrated in FIG. 3E, in this example rendered image as illustrated in FIG. 3F, two other users are visually depicted to be looking away from the user and viewing toward each other, as indicated by two arrows representing their respective lines of sight.

A communication client device as described herein may arrange image portions depicting other users—in rendered images on a display screen of an image display operating with the communication client device—in the same communication session using a layout as determined by another device such as the communication server (104 of FIG. 1A). Additionally, optionally or alternatively, the communication client device as described herein may arrange image portions depicting other users using a layout as autonomously (e.g., automatically, with user input, etc.) determined by the communication client device. Additionally, optionally or alternatively, the communication client device as described herein may arrange image portions depicting other users using any in a variety of candidate layouts selectable by the communication client device and/or the communication server (104 of FIG. 1A).

For example, instead of arranging image portions depicting the other users in a grid layout as illustrated in FIG. 3A through FIG. 3B, the communication client device may use a non-grid layout such as an ellipse layout to arrange image portions depicting the other users in accordance with an ellipse, as illustrated in FIG. 3D.

A tracking data portion as described herein—as received by a communication client device operated by a user—may or may not indicate another user is gazing at or viewing any specific user on an image display operated by the other user. For example, the other user may be gazing at a spatial location on the image display that does not correspond to any user in the communication session. The communication client device may directly use a camera-captured image portion depicting the other user in a rendered image for the other user. Additionally, optionally or alternatively, the communication client device may modify or adapt a contemporaneous or previously received image portion depicting the other user through image warping into a modified or adapted image portion that depicting the other user gazing at or viewing a current talker (or a talking user). Additionally, optionally or alternatively, the communication client device may modify or adapt a contemporaneous or previously received image portion depicting the other user through image warping into a modified or adapted image portion that depicting the other user gazing at or viewing out of a display screen of an image display operating in conjunction with the communication client device toward the user operating the communication client device.

In some operational scenarios, in a sequence of image portions depicting a specific other user, a communication client device as described herein may perform image interpolation to present or visually depict a relatively smooth (non-visually-disruptive) transition of the specific other user changing viewing directions from a first viewing direction at a first time to a second viewing direction at a second time later than the first time.

For the purpose of illustration only, it has been described that a communication client device performs receiving view direction data and adapting image portions or visual depictions of users. It should be noted that, in some operational scenarios, a device other than the communication client such as a communication server (e.g., 104 of FIG. 1A, etc.) may implement or perform some or all of these operations. For example, the communication server may compose or generate adapted image portions or visual depictions of other users relative to each user in the communication session based on view direction tracking data of some or all users in the communication session and encode/transmit (e.g., in real time, in near real time, etc.) a video or audiovisual signal to a respective communication client device operated by each such user for rendering to the user. As a result, the respective communication client device may be free from doing the operations already performed by the communication server.

5. Enhancing Remote Visual Interaction without Gaze Tracking

As noted, under techniques as described herein, rendered images or rendered visual depictions of users or participants in a communication session can be generated, adapted and/or modified from original camera captured image portions captured by cameras operating with communication client devices.

In some operational scenarios, instead of receiving original camera captured image portions as illustrated in FIG. 1C, modified or adapted image portions or modified or adapted visual depictions of users or participants can be carried or encoded in image streams (or sub-streams) originated from other communication client devices and delivered to a communication client device by way of the image streams or by way of an overall image stream (e.g., generated by the communication server (104) of FIG. 1A) encapsulating the image streams.

As shown in FIG. 1E, an original captured image portion or visual depiction (denoted as “Paul Real Camera”) of a user “Paul” may be captured by a (e.g., real, etc.) camera operating in conjunction with Paul's communication client device, which may be referred to as a source device for the visual depiction of Paul.

The original visual depiction (“Paul Real Camera”) of Paul can be modified or adapted, for example by the source device or another device or server operating with the source device, into recipient-specific modified or adapted visual depictions of Paul, respectively, for other communication client devices or other users operating the other communication client devices. In the present example, the recipient-specific modified or adapted visual depictions of Paul may include a first recipient-specific modified or adapted visual depiction (denoted as “Shwetha Virtual Camera”) of Paul for a first other user Shwetha or a first recipient communication client device operated by Shwetha, a second recipient-specific modified or adapted visual depiction (denoted as “Nikhil Virtual Camera”) of Paul for a second other user Nikhil or a second recipient communication client device operated by Nikhil, etc.

In some operational scenarios, as illustrated in FIG. 1E, the modification or adaptation of the original camera-captured visual depiction (“Paul Real Camera”) of Paul into the recipient-specific modified or adapted visual depictions (“Shwetha Virtual Camera” and “Nikhil Virtual Camera”) of Paul can be carried using virtual camera projection, which may not depend on, or may not make use of, gaze tracking.

While the original camera-captured visual depiction (“Paul Real Camera”) of Paul is captured from a (e.g., real, physical, etc.) camera perspective corresponding to a (e.g., real, physical, etc.) position of Paul's camera, the recipient-specific modified or adapted visual depictions (“Shwetha Virtual Camera” and “Nikhil Virtual Camera”) of Paul can be generated from warping the original camera-captured visual depiction (“Paul Real Camera”) of Paul with the camera perspective at the position (denoted as “Paul real camera pos”) of Paul's camera to virtual camera perspectives corresponding to virtual camera positions of the other users as the other users are visually depicted on Paul's image display.

More specifically, the first recipient-specific modified or adapted visual depiction (“Shwetha Virtual Camera”) of Paul may be generated from warping the original camera-captured visual depiction (“Paul Real Camera”) of Paul with the camera perspective at the position (“Paul real camera pos”) of Paul's camera to a first virtual camera perspective corresponding to a first virtual camera position (denoted as “Shwetha virtual camera pos”) of Shwetha as Shwetha is visually depicted on Paul's image display.

Similarly, the second recipient-specific modified or adapted visual depiction (“Nikhil Virtual Camera”) of Paul may be generated from warping the original camera-captured visual depiction (“Paul Real Camera”) of Paul with the camera perspective at the position (“Paul real camera pos”) of Paul's camera to a second virtual camera perspective corresponding to a second virtual camera position (denoted as “Nikhil virtual camera pos”) of Nikhil as Nikhil is visually depicted on Paul's image display.

In a first example, Paul's communication client device spatially arranges the visual depictions of the other users into different spatial regions/locations on Paul image display and hence has arrangement information (e.g., Shwetha at Left position, Nikhil at Right position, etc.) that identifies a respective specific spatial region/location among the different spatial regions/locations for each of the visual depictions of the other users on Paul's image display.

In a second example, a server (denoted as “Blue jeans”) may provide or instruct Paul's communication client device a spatial arrange of the visual depictions of the other users in different spatial regions/locations on Paul image display. Paul's communication client device can receive, from the server, arrangement information (e.g., Shwetha at Left position, Nikhil at Right position, etc.) that identifies a respective specific spatial region/location among the different spatial regions/locations for each of the visual depictions of the other users on Paul's image display. For example, a position (e.g., a symmetric point, an axis point, a center point, etc.; denoted as “Blue jeans Shwetha square pos”) of a specific spatial region/location used to depict Shwetha may be selected or determined to be the first virtual camera position (“Shwetha virtual camera pos”) of Shwetha to which the first virtual camera perspective corresponds.

Additionally, optionally or alternatively, face detection operations may be performed by Paul's communication client device using AI/ML based techniques including but not limited using ANNs such as convolutional neural networks to detect logical boxes/regions in which human faces are detected.

For example, Shwetha's face on the left of a rendered image on Paul's image display may be detected. A (e.g., ML generated, etc.) face mesh may be placed onto the detected face to identify or locate pupils as well as a mid-position (denoted as “Shwetha ML face mesh eye pos”) of an interpupil line connecting the pupils. This mid-position may be selected or determined to be the first virtual camera position (“Shwetha virtual camera pos”) of Shwetha to which the first virtual camera perspective corresponds.

A first warp vector to be used by image warping operations (denoted as Warp( . . . )) to warp the original camera-captured image portion or visual depiction of Paul into the first recipient-specific modified or adapted visual depiction (“Shwetha Virtual Camera”) of Paul to be used by Shwetha's communication client device to render on Shwetha's image display may be constructed using a combination of the position (“Paul real camera pos”) of Paul's camera, display screen size (denoted as “monitor size”) of Paul's image display, the first virtual camera position (“Shwetha virtual camera pos”), etc. The first virtual camera position (“Shwetha virtual camera pos”) may be determined, identified or represented based at least in part on the position (“Blue jeans Shwetha square pos”) of the specific spatial region/location used to depict Shwetha on Paul's image display. Additionally, optionally or alternatively, the first virtual camera position (“Shwetha virtual camera pos”) may be determined, identified or represented based at least in part on the mid-position (“Shwetha ML face mesh eye pos”) of the interpupil line of Shwetha, if available from AI/ML based face detection and/or face mesh operations.

This first warp vector can then be used by the image warping operations (Warp( . . . )) to warp the original camera-captured image portion or visual depiction of Paul into the first recipient-specific modified or adapted visual depiction (“Shwetha Virtual Camera”) of Paul to be used by Shwetha's communication client device to render on Shwetha's image display. In some operational scenarios, AI/ML based depth analysis/estimation operations can be performed on the original camera captured image portion or visual depiction of Paul to use image texture information (e.g., represented by pixel values such as RGB values, YUV values, etc.) of pixels in the image portion or visual depiction to estimate or predict respective depth values of these pixels relative to the position (“Paul real camera pos”) of Paul's camera. Once the depth values of pixels from Paul's camera are estimated, predicted and/or determined, the image warping operations (Warp( . . . )) can apply (e.g., non-AI based, non-ML based, etc.) geometric or camera perspective transformations to these pixels to generate the first recipient-specific modified or adapted visual depiction (“Shwetha Virtual Camera”) of Paul. As illustrated in FIG. 1F, the original camera-captured image portion or visual depiction of Paul may visually depict Paul as looking in a left down direction 140 (toward a visual depiction of Shwetha on Paul's image display), whereas the first recipient-specific modified or adapted visual depiction (“Shwetha Virtual Camera”) of Paul visually depict Paul as looking in a straight direction 142 (e.g., toward (e.g., the real, etc.) Shwetha located in front of Shwetha's image display, etc.).

Additionally, optionally or alternatively, a second warp vector to be used by the image warping operations (Warp( . . . )) to warp the original camera-captured image portion or visual depiction of Paul into the second recipient-specific modified or adapted visual depiction (“Nikhil Virtual Camera”) of Paul to be used by Nikhil's communication client device to render on Nikhil's image display may be constructed and then be used by the image warping operations (Warp( . . . )) to warp the original camera-captured image portion or visual depiction of Paul into the second recipient-specific modified or adapted visual depiction (“Nikhil Virtual Camera”) of Paul. As Paul is looking away from Nikhil's virtual camera perspective and looking into Shwetha's virtual camera perspective, the second recipient-specific modified or adapted visual depiction (“Nikhil Virtual Camera”) of Paul as rendered by Nikhil's communication client device on Nikhil's image display will also correctly visually depict Paul as looking away from Nikhil.

FIG. 1G illustrates example operational scenarios in which a physical or real camera of a user (“Paul”) is used to acquire a visual depiction of Paul from a physical and real camera perspective while Paul is looking, on Paul's image display, at a visual depiction of a first other user (“Shwetha”) and away from a visual depiction of a second other user (“Nikhil”).

The visual depiction of Paul of the real camera perspective is warped using image warping operations into a first visual depiction of Paul of a first virtual camera perspective of a first virtual camera at a first spatial location (e.g., a geometric center of a spatial portion of Shwetha's visual depiction, a mid-point of interpupil distance of a detected face or face mesh, etc.) of Shwetha's visual depiction on Paul's image display. The first visual depiction of Paul of the first virtual camera perspective may be included in a first video feed (denoted as “Paul-Shwetha feed”) and delivered to Shwetha's communication client device for rendering on Shwetha's image display on which Paul will be looking straight at (e.g., the real, physical, etc.) Shwetha in front of Shwetha's image display.

The visual depiction of Paul of the real camera perspective is also warped using image warping operations into a second visual depiction of Paul of a second virtual camera perspective of a second virtual camera at a second spatial location (e.g., a geometric center of a spatial portion of Nikhil's visual depiction, a mid-point of interpupil distance of a detected face or face mesh, etc.) of Nikhil's visual depiction on Paul's image display. The second visual depiction of Paul of the second virtual camera perspective may be included in a second video feed (denoted as “Paul-Nikhil feed”) and delivered to Nikhil's communication client device for rendering on Nikhil's image display on which Paul will be looking away from (e.g., the real, physical, etc.) Nikhil in front of Nikhil's image display.

Generally speaking, a communication session may involve three or more users or viewers. Under techniques as described herein, a virtual camera may be assigned to each of other users/viewers with respect to a user/viewer. A real camera visual depiction of the user/viewer can be warped to respective virtual camera visual depictions of the user/viewer for the other users/viewers, which may be carried or delivered in separate video feeds (or streams) to communication client devices of the other users/viewers for rendering on image displays of the other users/viewers, respectively. Each of these video feeds or streams may carry a different image or image portion of the user/viewer such as Paul. Some or all of these techniques can be implemented or performed without eye tracking and/or special hardware.

The image warping operations as described herein can be performed with depth information, for example in relation to the real camera. In an example, the depth information may be obtained by a depth of field sensor operating with a real or physical camera to generate, obtain or derive the depth information in relation to the camera. In another example, the depth information may be obtained with an AI/ML depth prediction model using texture information of an image to estimate or predict individual depths of pixels (e.g., foreground, background, different image features, etc.) in an acquired image. As visual depictions of a user on a viewer's image display contain relatively small modifications or changes from one another over time, depth information are relatively stable from frame to frame. Hence, relatively low sampling rates or relatively low latency in depth information acquisition may be implemented or performed with either the depth of field sensor and/or predictive model to obtain or generate relatively accurate or stable depth information, for example for placing any of virtual cameras. A virtual camera location can then be used along with a position of the real camera, monitor size or display screen size, specific (e.g., server-designated, communication-client-device-designated, both server and client device designated, etc.) display screen spatial portions assigned to display visual depictions of other users, etc. A 2D or 3D displacement or difference between the real camera position and the virtual camera position can then be used in the image warping operations to generate virtual camera visual depictions of the user/viewer.

Additionally, optionally or alternatively, some or all virtual cameras may be replaced by physical or real cameras. In a first example as illustrated in FIG. 1H, in some operational scenarios, two or more physical or real cameras may be placed at spatial portions designated to depict two or more other users on a user/viewer's image display. Respective real visual depictions acquired with these physical or real cameras may be sent or delivered to communication client devices of the other users for rendering on the other users' image displays, respectively, instead of or in addition to virtual camera visual depictions generated using image warping. Hence, in some operational scenarios, no gaze tracking as well as no image warping is needed to provide enhanced remote visual interactions in communication sessions. In a second example, a physical camera (e.g., a center camera, etc.) may be placed on screen in an image display, for example at a display screen center position while another physical camera (e.g., a side camera, etc.) may be placed off screen. Gaze tracking may be used to determine a specific other user whose visual depiction is being gazed at or viewed by a user/viewer of the image display. For the specific other user, a visual depiction of the user/viewer from the onscreen camera may be sent to the specific other user's communication client device for rendering. For remaining other users, a visual depiction of the user/viewer from the off screen camera may be sent to the remaining other users' communication client devices for rendering. Hence, in some operational scenarios, multiple physical cameras may be used in combination with gaze tracking to enhance remote visual interactions in communication sessions.

FIG. 1I illustrates an example configuration of a communication client device 102 (e.g., any of 102-1 through 102-N of FIG. 1A, etc.). The system (102) can be implemented with one or more computing devices and operated by a user in a communication session with enhanced remote visual interaction. The one or more computing devices comprise any combination of hardware and software implementing various components, including but not necessarily limited to only: virtual cameras 150, a camera interface 116, a depiction data communicator 152, an image stream communicator 118, an interactive image generator 120, and so on.

The communication client device (102) or the camera interface (116) therein may receive or collect real time or near real time camera captured image data from one or more cameras 114 operatively linked with the communication client device (102) over one or more internal or external data connections. The collected camera image data may contain a specific image portion visually depicting the user operating the communication client device (102) in real time or near real time.

The communication client device (102) or the depiction data communicator (152) therein may exchange or communicate (real time or near real time) visual depiction data 154 with a communication server such as 104 of FIG. 1A. In some operational scenarios, rendered images on the user's image display may be provided by the communication server (104 of FIG. 1A). In these operational scenarios, visual depiction data specifying spatial regions/portions/locations at or in which the other users are respectively rendered on the user's image display may be provided to and received by the communication client device (102).

The communication client device (102) or the virtual cameras (110) therein may generate in real time or near real time two or more virtual camera visual depictions of the user for two or more other users, for example by performing image warping operations on real camera visual depiction(s) based at least in part on real camera position(s), virtual camera positions, display screen size of the user's display screen, depiction data relating to visual depictions of the other users on the user's display screen, ML or non-ML depth data, ML detected face or face mesh, etc.

The communication client device (102) or the image stream communicator (118) therein may exchange or communicate (in real time or near real time (e.g., virtual camera only, physical camera only, a combination of virtual camera(s) and/or physical camera(s), etc.) visual depictions of the user as image stream data 126 with other communication client devices in the same communication session.

### 6. Example Process Flows

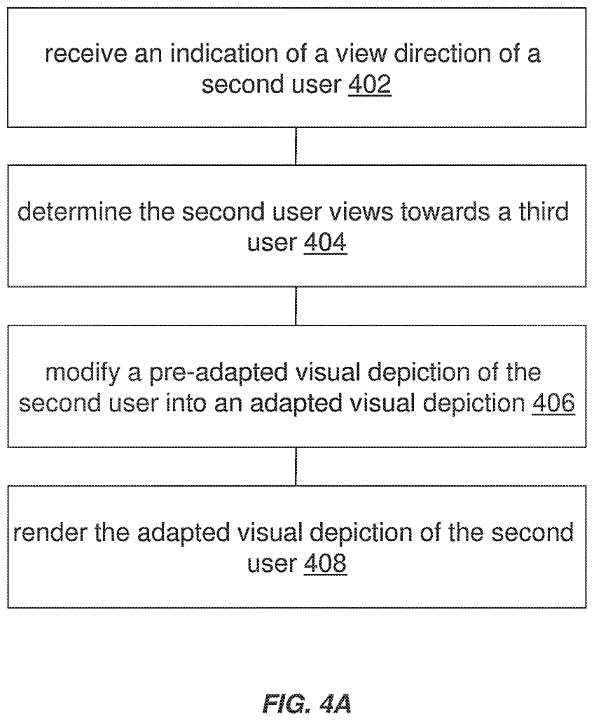

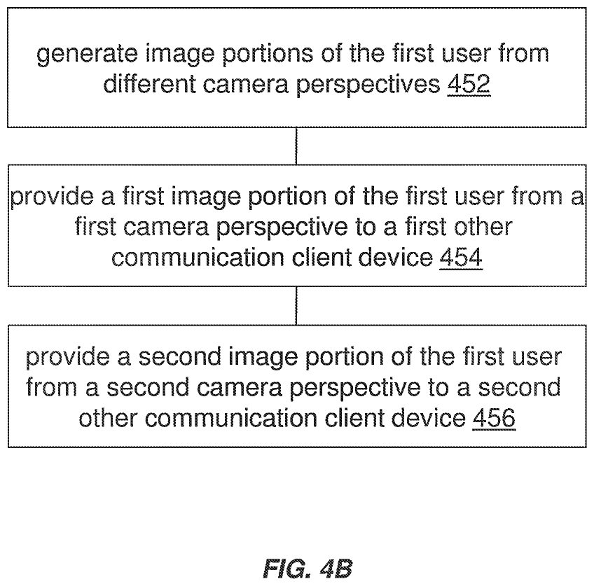

FIG. 4A illustrates an example process flow according to an example embodiment of the present invention. In some example embodiments, one or more computing devices or components may perform this process flow. In block 402, a communication client device operated by a first user in a communication session receives a viewing direction tracking data portion indicating a view direction of a second user in the communication session.

In block 404, the communication client device determines that the view direction of the second user is towards a third user at a first time point in the communication session.

In block 406, the communication client device uses the view direction of the second user to modify a pre-adapted visual depiction of the second user into an adapted visual depiction of the second user.

In block 408, the communication client device renders the adapted visual depiction of the second user, to the first user, on an image display operating with the communication client device.

In an embodiment, the viewing direction tracking data portion is generated from eye tracker data collected by a second communication client device operated by the second user.

In an embodiment, the third user is one of the first user, or a user other than the first and second users.

In an embodiment, the pre-adapted visual depiction of the second user is one of: a camera-generated image portion generated contemporaneously with the viewing direction tracking data, or an image portion previously received by the communication client device.

In an embodiment, the adapted visual depiction of the second user is generated with a machine learning predictive model.

In an embodiment, operational parameters of the machine learning predictive model are optimized in a training phase by a machine learning system other than the communication client device and downloaded to the communication client device to perform image warping in accordance with the view direction from a different view direction represented in the pre-adapted visual depiction of the second user.

In an embodiment, the communication session includes the first user and two or more other users including the second user; the first user and the two or more other users in the communication session operate a plurality of communication client devices to perform audiovisual communications with one another; each of the first user and the two or more other users in the communication session operates a respective communication client device in the plurality of communication client devices.

In an embodiment, the plurality of communication client devices communicates with one another through a communication server.

In an embodiment, visual depictions of other users in communication with the first user in the communication session is visually arranged on the image display in one of: a grid layout or a non-grid layout.

In an embodiment, the adapted visual depiction of the second user represents one of: a two-dimensional visual depiction or a three-dimensional visual depiction.

In an embodiment, the communication client device further performs: receiving, by the communication client device o, a second viewing direction tracking data portion indicating a second view direction of the second user in the communication session; determining that the second view direction of the second user is turning away from the third user at a second time point in the communication session, the second time point being subsequent to the first time point; using the second view direction of the second user to modify a second pre-adapted visual depiction of the second user into a second adapted visual depiction of the second user; rendering the second adapted visual depiction of the second user, to the first user, on the image display operating with the communication client device.

In an embodiment, the third user is talking at the first time point in the communication session; wherein the communication client device operates with audio devices to render audio sounds, to the first user, based on an audio signal portion originated from an audio signal capturing device operated by the third user.

In an embodiment, the communication client device receives a third viewing direction tracking data portion indicating a third view direction of the third user at the first time point in the communication session; the third view direction of the third user is towards the second user at the first time point in the communication session; the third view direction of the third user is used to modify a third pre-adapted visual depiction of the third user into a third adapted visual depiction of the third user; the third adapted visual depiction of the third user is rendered, to the first user, along with the adapted visual depiction of the second user on the image display operating with the communication client device.

FIG. 4B illustrates an example process flow according to an example embodiment of the present invention. In some example embodiments, one or more computing devices or components may perform this process flow. In block 452, a communication client device operated by a first user in a communication session generates two or more image portions of the first user from two or more different camera perspectives for two or more other users in the communication session.

In block 454, the communication client device provides a first image portion of the first user from a first camera perspective to a first other communication client device operated by a first other user in the two or more other users.

In block 456, the communication client device provides a second image portion of the first user from a second camera perspective to a second other communication client device operated by a second other user in the two or more other users, the first camera perspective being different from the second camera perspective.

In an embodiment, both the first image portion and the second image portion are generated from image warping operations.

In an embodiment, the image warping operations are performed using a warping vector generated from one or more of: a physical camera position, or a virtual camera position.

In an embodiment, the virtual camera position is determined from one or more of: a display screen size of the image display, a position determined from a spatial portion designated to render a visual depiction of an other user on the image display, a spatial location of a detected face depicting the other user, etc.

In an embodiment, at least one of the first image portion or the second image portion is a real camera image portion.

In an embodiment, the foregoing operations are performed without gaze tracking.

In an embodiment, the foregoing operations are performed without image warping.

In various example embodiments, an apparatus, a system, an apparatus, or one or more other computing devices performs any or a part of the foregoing methods as described. In an embodiment, a non-transitory computer readable storage medium stores software instructions, which when executed by one or more processors cause performance of a method as described herein.

Note that, although separate embodiments are discussed herein, any combination of embodiments and/or partial embodiments discussed herein may be combined to form further embodiments.

### 7. Implementation Mechanisms-Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

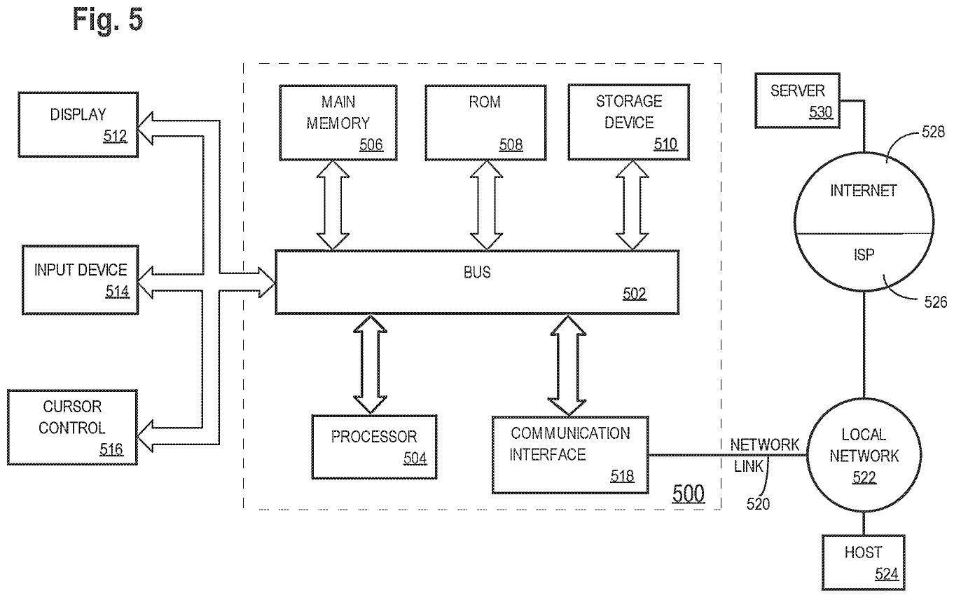

For example, FIG. 5 is a block diagram that illustrates a computer system 500 upon which an example embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504.

A storage device 510, such as a magnetic disk or optical disk, solid state RAM, is provided and coupled to bus 502 for storing information and instructions.

Computer system 500 may be coupled via bus 502 to a display 512, such as a liquid crystal display, for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. Equivalents, Extensions, Alternatives and Miscellaneous

In the foregoing specification, example embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
receiving, by a communication client device operated by a first user in a communication session, a viewing direction tracking data portion indicating a view direction of a second user in the communication session;
determining that the view direction of the second user is towards a third user at a first time point in the communication session;
using the view direction of the second user to modify a pre-adapted visual depiction of the second user into an adapted visual depiction of the second user; and
rendering the adapted visual depiction of the second user, to the first user, on an image display operating with the communication client device,
wherein the adapted visual depiction of the second user is generated from image warping operations, wherein the image warping operations take into account a first spatial region on the image display assigned to display the adapted visual depiction of the second user.

2. The method of claim 1, wherein the viewing direction tracking data portion is generated from eye tracker data collected by a second communication client device operated by the second user.

3. The method of claim 1, wherein the third user is one of the first user, or a user other than the first and second users.

4-20. (canceled)

21. The method of claim 3, wherein the third user is a user other than the first and second users, and wherein the image warping operations further take into account a second spatial region on the image display assigned to display image portions depicting the third user.

22. The method of claim 1, wherein the pre-adapted visual depiction of the second user is one of: an image portion generated from the camera of the second user generated contemporaneously with the viewing direction tracking data, or an image portion previously received by the communication client device.

23. The method of claim 1, wherein the image warping is performed with a machine learning predictive model.

24. The method of claim 23, wherein operational parameters of the machine learning predictive model are optimized in a training phase by a machine learning system other than the communication client device and downloaded to the communication client device to perform the image warping in accordance with the view direction from a different view direction represented in the pre-adapted visual depiction of the second user.

25. The method of claim 24, wherein the communication session includes the first user and two or more other users including the second user, wherein the first user and the two or more other users in the communication session operate a plurality of communication client devices to perform audiovisual communications with one another, and wherein each of the first user and the two or more other users in the communication session operates a respective communication client device in the plurality of communication client devices.

26. The method of claim 25, wherein the plurality of communication client devices communicates with one another through a communication server.

27. The method of claim 26, wherein visual depictions of other users in communication with the first user in the communication session is visually arranged on the image display in one of: a grid layout or a non-grid layout.

28. The method of claim 27, wherein the adapted visual depiction of the second user represents one of: a two-dimensional visual depiction or a three-dimensional visual depiction.

29. The method of claim 28, further comprising:
receiving, by the communication client device, a second viewing direction tracking data portion indicating a second view direction of the second user in the communication session;
determining that the second view direction of the second user is turning away from the third user at a second time point in the communication session, wherein the second time point is subsequent to the first time point;
using the second view direction of the second user to modify a second pre-adapted visual depiction of the second user into a second adapted visual depiction of the second user; and
rendering the second adapted visual depiction of the second user, to the first user, on the image display operating with the communication client device.

30. The method of claim 29, wherein the third user is talking at the first time point in the communication session and wherein the communication client device operates with audio devices to render audio sounds, to the first user, based on an audio signal portion originated from an audio signal capturing device operated by the third user.

31. The method of claim 30, wherein the communication client device receives a third viewing direction tracking data portion indicating a third view direction of the third user at the first time point in the communication session, wherein the third view direction of the third user is towards the second user at the first time point in the communication session, wherein the third view direction of the third user is used to modify a third pre-adapted visual depiction of the third user into a third adapted visual depiction of the third user, and wherein the third adapted visual depiction of the third user is rendered, to the first user, along with the adapted visual depiction of the second user on the image display operating with the communication client device.

32. A non-transitory computer readable storage medium, storing software instructions, which when executed by one or more processors cause performance of the method recited in any of claim 1.

33. A computing device comprising one or more processors and one or more storage media, storing a set of instructions, which when executed by one or more processors cause performance of the method recited in claim 1.

34. A method comprising:
generating, by a communication client device operated by a first user in a communication session, two or more image portions of the first user from two or more different camera perspectives for two or more other users in the communication session;
providing, by the communication client device, a first image portion of the first user from a first camera perspective to a first other communication client device operated by a first other user in the two or more other users; and
providing, by the communication client device, a second image portion of the first user from a second camera perspective to a second other communication client device operated by a second other user in the two or more other users, the first camera perspective being different from the second camera perspective, wherein both the first image portion and the second image portion are generated from image warping operations, wherein the image warping operations for the first image portion are performed using a first warping vector generated from a physical position of a camera operating in conjunction with the communication client device and a virtual camera position of the first other user on an image display operating with the communication client device and the image warping operations for the second image portion are performed using a second warping vector generated from the physical position of the camera and a virtual camera position of the second other user on the image display.

35. The method of claim 34, wherein the virtual camera position is determined from one or more of: a display screen size of the image display, a position determined from a spatial portion designated to render a visual depiction of an other user on the image display, or a spatial location of a detected face depicting the other user.

36. The method of claim 34, wherein the method is performed without gaze tracking.
